(19) United States
(12) Patent Application Publication
(10) Pub. No.: US 2020/0220319 A1
(43) Pub. Date: Jul. 9, 2020

(54) FEMTOSECOND MODE-LOCKED LASER WITH REDUCED RADIATION AND TEMPERATURE SENSITIVITY

(71) Applicant: Honeywell International Inc., Morris Plains, NJ (US)

(72) Inventors: Chellappan Narayanan, Phoenix, AZ (US); Jeffrey Earl Lewis, Phoenix, AZ (US); Sorin Mosor, Peoria, AZ (US); Tiequn Qiu, Glendale, AZ (US)

(73) Assignee: Honeywell International Inc., Morris Plains, NJ (US)

(21) Appl. No.: 16/244,012

(22) Filed: Jan. 9, 2019

(51) Int. Cl. H01S 3/11; H01S 3/08; H01S 3/10; H01S 3/067; H01S 3/16; H01S 3/23; H01S 3/13; H01S 3/094

(52) U.S. Cl. CPC H01S 3/1118; H01S 3/08013; H01S 3/1003; H01S 3/10061; H01S 3/06754; H01S 3/094; H01S 3/1608; H01S 3/2316; H01S 3/1305; H01S 3/1301; H01S 3/06716

(57) ABSTRACT

In an example, a mode-locked laser includes a resonator cavity having a saturable absorber, a hollow core fiber coupled to the saturable absorber, and an optical amplifier optically coupled between the hollow core fiber and an output coupler. The mode-locked laser further includes a first pump laser and a wavelength division multiplexer coupled to the first pump laser. The wavelength division multiplexer is configured to couple light from the first pump laser into the resonator cavity to pump the optical amplifier. The mode-locked laser is configured to generate a pulse waveform at a repetition rate of approximately 100 MHz to 200 MHz.

### STATEMENT REGARDING FEDERALLY SPONSORED RESEARCH OR DEVELOPMENT

This invention was made with Government support under FA9453-17-C-0039 awarded by AFRL. The Government has certain rights in the invention.

### BACKGROUND

Optical frequency combs are powerful instruments which can provide millions of mutually-coherent, evenly spaced comb modes. These comb modes are individual energized frequencies evenly dispersed between frequencies lacking any energy. These frequency comb modes are useful in well-controlled laboratory environments and increasingly in less well-controlled laboratory environments. An optical frequency comb relies heavily on the use of a mode-locked laser that produces a pulse waveform at a steady, unchanging frequency. Optical frequency combs have many applications including, for example, the measurement of absolute optical frequencies, high-precision spectroscopy, optical clocks, optical sensing, and distance measuring.

### SUMMARY

In an example, a mode-locked laser includes a resonator cavity having a saturable absorber, a hollow core fiber coupled to the saturable absorber, and an optical amplifier optically coupled between the hollow core fiber and an output coupler. The mode-locked laser further includes a first pump laser and a wavelength division multiplexer coupled to the first pump laser. The wavelength division multiplexer is configured to couple light from the first pump laser into the resonator cavity to pump the optical amplifier. The mode-locked laser is configured to generate a pulse waveform at a repetition rate of approximately 100 MHz to 200 MHz.

### DRAWINGS

Understanding that the drawings depict only some embodiments and are not therefore to be considered limiting in scope, the exemplary embodiments will be described with additional specificity and detail using the accompanying drawings, in which:

FIG. 1A is a block diagram of example mode-locked laser using a hollow core fiber according to an aspect of the present disclosure;

FIG. 1B is a block diagram of example mode-locked laser using a hollow core fiber according to an aspect of the present disclosure;

FIG. 1C is a block diagram of example mode-locked laser using a hollow core fiber according to an aspect of the present disclosure; and

FIG. 2 is a block diagram of example optical frequency comb generator according to aspects of the present disclosure.

In accordance with common practice, the various described features are not drawn to scale but are drawn to emphasize specific features relevant to the example embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made.

Optical oscillators serve to promote lasing of light. A mode-locked laser consists of a gain medium and a saturable absorber inside an optical cavity. The gain medium is either electrically or optically pumped to generate the initial light; the optical cavity is a linear resonator cavity (such as, for example, a Fabry-Perot resonator) formed by two mirror ends at the opposite end of the cavity or a ring resonator cavity formed by a closed circular optical path. The optical cavity can also include one or more optical fibers to increase the length of the cavity. Mode-locked lasers are the fundamental building blocks necessary for generating optical frequency combs. Mode-lacking of a laser is achieved by building a laser cavity that is low loss for intense pulses but high loss for a low-intensity continuous beam. A device that achieves this functionality and allows intense pulses to resonate in the cavity is a saturable absorber. An example of a saturable absorber is the semiconductor saturable absorber mirror (SESAM). The dispersion and gain of the cavity are parameters that are tuned to achieve mode locking. When a laser is mode-locked it outputs a periodic pulsed waveform in the time domain, which translates to comb of frequency modes in the frequency domain. In other words, the discrete frequency modes supported by the cavity are in phase and add coherently to generate a periodic pulsed waveform. The period of the pulsed waveform in the time domain or the mode spacing between the individual frequency modes in the frequency domain is determined by the refractive index of the medium in the optical cavity and the length of the optical cavity. A stabilized optical frequency comb—frequency drift compensated using feedback servo loops—is used in high precision applications such as spectroscopy and clocks.

Unlike in well-controlled laboratory environments, mode-locked lasers, and optical frequency comb generators that utilize them, are subject to great fluctuations in radiation and temperature in outer space. Prior examples of mode-locked lasers alter fundamentally when exposed to radiation, and especially when exposed to large amounts of radiation. For example, when a mode-locked laser cavity is exposed to radiation, the refractive index of solid core optical fibers included within the mode-locked laser cavity changes, which modifies the optical length of the mode-locked laser cavity and the repetition rate of pulse waveforms generated by the mode-locked laser. Changes in the refractive index of the optical fiber can occur due to fluctuations in temperature as well, but the effect on the refractive index from temperature is much less than the effect from radiation. In outer space, the refractive index of an optical fiber can be significantly affected beyond the compensation ranges of feedback servo loops, which causes large changes in the pulse repetition frequency of the mode-locked laser over time. These changes can be large enough to jeopardize the characteristics of the mode-locked laser (for example, repetition rate), and the usefulness of the mode-locked laser and the optical frequency comb generator utilizing the mode-locked laser is diminished.

The examples described below enable the operation of the mode-locked laser in an environment with exposure to large amounts of radiation by including a hollow core fiber within the resonator cavity (hereinafter used interchangeably with resonator). Using a hollow core fiber within the mode-locked laser cavity reduces the distorting effect radiation and/or temperature can have on the optical length of the laser cavity. The reduction allows for feedback loops to be used to sufficiently compensate the mode-locked laser for the effects of radiation and/or temperature. Ideally, modifications to the mode-locked laser would not be required to compensate for the effects of radiation and/or temperature. Further, by controlling the particular properties of the hollow core fiber, the mode-locked laser can be fine-tuned for use for particular applications. The examples described below also include an optical frequency comb generator that is less susceptible to radiation and/or temperature fluctuation in space.

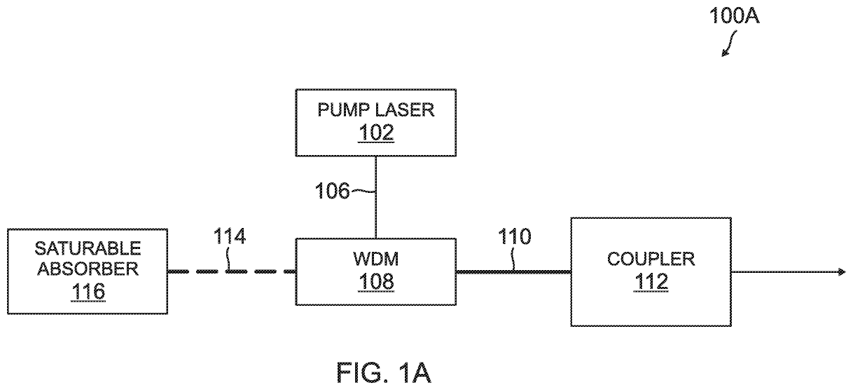

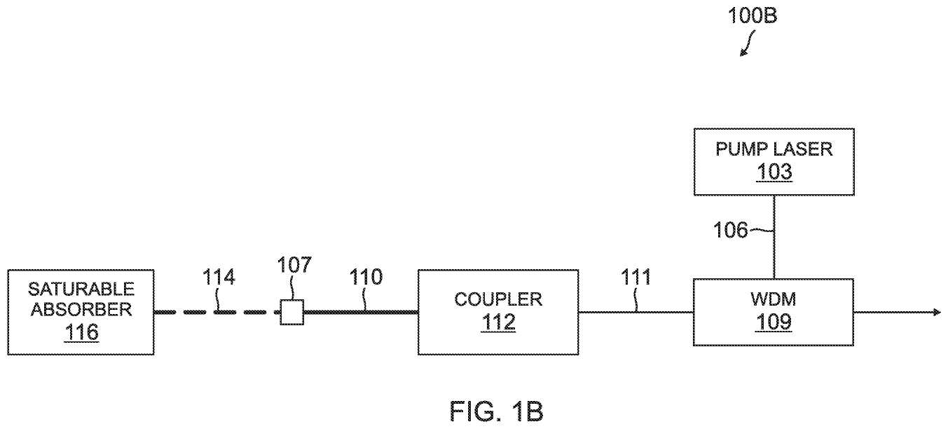

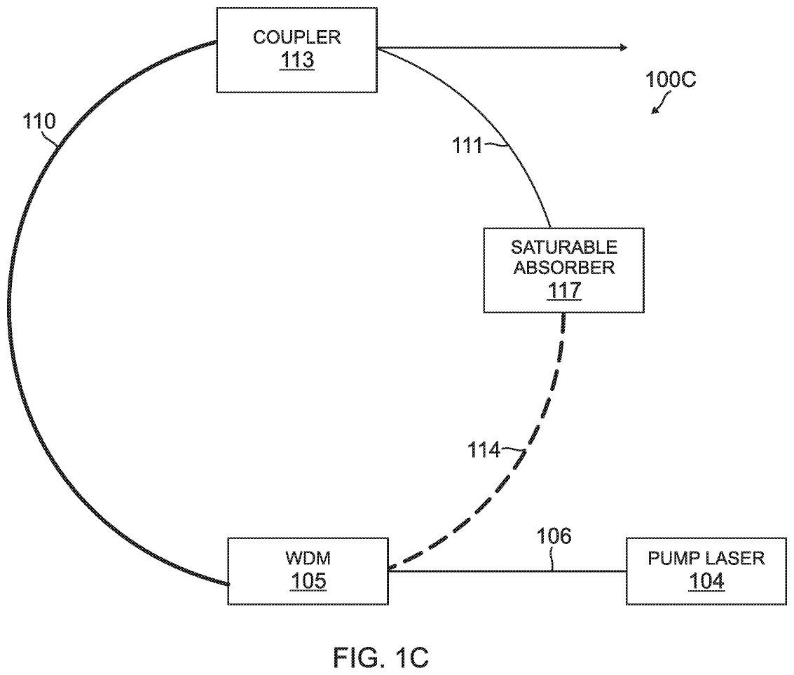

FIGS. 1A, 1B and 1C are block diagrams of alternative examples of mode-locked lasers 100A, 100B, 100C according to the present disclosure. In some examples, the mode-locked laser 100 is a femtosecond mode-locked laser resonator, which is configured to generate a femtosecond pulse waveform. In some examples, the mode-locked laser includes a linear resonator (such as, for example, a Fabry-Perot resonator), which is configured such that light within the cavity of the linear resonator reflects between two mirrors through a gain medium. In some examples, the mode-locked laser includes a ring resonator, which is configured such that the light within the cavity of the ring resonator resonates through a gain medium.

FIG. 1A is a block diagram of an example mode-locked laser 100A that utilizes a hollow core fiber 114 according to some aspects of the present disclosure. In the example shown in FIG. 1A, the mode-locked laser 100A includes a pump laser 102, a wavelength division multiplexer (WDM) 108, an optical amplifier 110, an output coupler 112, the hollow core fiber 114, and a saturable absorber 116.

In the example shown in FIG. 1A, the pump laser 102 is optically coupled to the WDM 108 using one or more optical fibers 106. In some examples, the pump laser 102 is optically coupled to the one or more optical fibers 106 by splicing the fibers or with a FC/APC connector and an isolator. In some examples, the one or more optical fibers 106 include a 980 nm polarization maintaining solid core fiber or standard single mode solid core fiber which is not polarization maintaining.

Connections to the optical fibers 106 are implemented using a splice or free-space coupling. In some examples, the splice and free-space coupling are zero degree aligned and are polarization maintaining. Thus, when connecting a component to the optical fibers 106 the splice or free-space coupling maintains the frequency and polarization of the light.

In the example shown in FIG. 1A, the WDM 108 is optically coupled to the hollow core fiber 114 on one side and to the optical amplifier 110 on the other. Together, the hollow core fiber 114 and the optical amplifier 110 create a path along which light can traverse the cavity without significant loss. In some examples, the hollow core fiber 114 and the optical amplifier 110 are polarization maintaining. In some examples, the optical couplings between the WDM 108, the hollow core fiber 114, and the optical amplifier 110 are polarization maintaining.

In some examples, the output coupler 112 and the saturable absorber 116 of the mode-locked laser 100A include mirrors and are positioned at opposite ends of the optical cavity. In some examples, the saturable absorber 116 is a SESAM. In some examples, the output coupler 112 is a dielectric mirror. In the example shown in FIG. 1A, the saturable absorber 116 optically couples to the end of the hollow core fiber 114 opposite the WDM 108, and the output coupler 112 optically couples to the end of the optical amplifier 110 opposite the WDM 108. In some examples, the saturable absorber 116 is optically coupled to the hollow core fiber 114 via a fiber splice or free-space coupling and the dielectric mirror 112 is optically coupled to the optical amplifier 110 via free space coupling or by with a FC/APC connector tip coated with the dielectric mirror. The output coupler 112 and the saturable absorber 116 are optically coupled such that light can traverse the length of the resonator cavity between the two mirrors. Light traveling within the resonator cavity can reflect off the two mirrors 112, 116 such that light within the resonator cavity resonates between the two mirrors 112, 116 at discrete frequencies until it exits the resonator cavity.

The output coupler 112 in the examples shown in FIG. 1A consists of a transparent substrate adhered to layers of dielectric material. The characteristics of the output coupler 112 depend on the composition and layering of the dielectric material such that the dielectric mirror can both transmit and reflect light. In some examples, the output coupler 112 is a coating applied to a FC/PC connector. In some examples, the output coupler 112 is configured to transmit a particular percentage of the light directed towards the output coupler 112 and reflect a particular percentage of the light directed toward the output coupler 112. In some examples, the output coupler 112 is configured to transmit a particular frequency band of light. In some examples, the output coupler 112 is configured to reflect and transmit light such that the light traveling along the resonator cavity lases.

The saturable absorber 116 is configured to facilitate in the generation of a mode-locked laser. Generally, a saturable absorber 116 configured as a SESAM consists of a mirror structure with an incorporated saturable absorber. In some examples, the saturable absorber 116 consists of a Bragg mirror with a layer of semiconductor saturable film adjacent. In other examples, the saturable absorber 116 consists of a substrate material, with layers of dielectric film, and a semiconductor material layer. The saturable absorber 116 facilitates generation of ultrashort pulses for passive mode locking of the mode-locked laser 100A. In some examples, the saturable absorber 116 optically couples to the hollow core fiber 114 with free-space coupling.

The optical amplifier 110 in the example shown in FIG. 1A is configured to amplify the light traveling along its length. The optical amplifier 110, which is also referred to as an active fiber or a doped fiber herein, serves to amplify the light within the resonator cavity through stimulated emission. In some examples, the optical amplifier 110 is an erbium-doped fiber. In such examples, the pump laser 102 is configured to produce light at a wavelength of 1480 nm, which is an example of pump wavelength for erbium-doped fibers. In some examples, the optical amplifier 110 is doped using a different rare-earth mineral, for example neodymium, ytterbium, thulium, praseodymium, holmium, or the like. In such examples, the wavelength of the light generated by the pump laser 102 is configured based on the pump wavelength for the particular mineral used to dope the fiber. In some examples, the optical amplifier 110 contains a 7 μm core.

The hollow core fiber 114 comprises an optical fiber with a hollow region along the length of the fiber. Hollow core fibers operate under a different principle than those of solid core fibers. In particular, where solid core fibers rely on the higher index of refraction of the solid core to guide light, hollow core fibers rely on a mechanism called bandgap guidance where a defect (hollow core) is introduced in an opaque periodic lattice to guide light in the air region. In some examples, the hollow region of the hollow core fiber is a vacuum. In other examples the hollow region is filled with a gas (for example, air). It should be understood that a number of gases may be used depending on the desired characteristics of the hollow core fiber 114. The hollow region of the hollow core fiber 114 is surrounded by a solid micro-structured cladding material, which has a higher index of refraction than the hollow core. In some examples, the solid cladding is made from silica (for example, glass). However, it is contemplated that other mediums may be used depending on the desired properties of the hollow core fiber 114.

In some examples, the hollow core fiber 114 is configured to be a nested hollow core fiber 114 in which at least one hollow core nests within the hollow core fiber 114. In some examples, the cross-section of the nested hollow core fiber comprises a central vacant region, or core, surrounded by a series of tubes, for example, made from glass; however, it is contemplated that other materials may be used. The cross-section for such tubes can be circular, elliptical, or the like and the tubes may be filled with a vacuum or gas (for example, air).

In some examples, the hollow core fiber 114 is configured such that its total dispersion is anomalous. Thus, in some examples, the hollow core fiber 114 is configured such that the index of refraction of the hollow core fiber increases as the wavelength of the light increases. In some examples, the periodicity of the micro-structured cladding region with air holes used to guide light in a hollow core can be modified to produce anomalous dispersion.

The period or frequency of the pulse waveform output by the mode-locked laser 100A is determined by the optical path length of the cavity between the output coupler 112 and the saturable absorber 116. In some examples, the mode-locked laser 100A is configured to operate at a repetition rate of greater than 100 MHz. In some examples, the repetition rate of the mode-locked laser 100A is configured to be between 100 MHz and 200 MHz. In a particular example, the length of the resonator cavity is approximately 100 cm long with the optical amplifier being approximately 14.5 cm long and the hollow core fiber 114 being approximately 84.5 cm long. In some examples, the resonator cavity is configured to be approximately 50 cm to 1 m in length.

In some examples, at least one piezoelectric-based fiber stretcher (not-shown) may be used in the resonator cavity. In some examples, the at least one piezoelectric-based fiber stretcher may be optically coupled to the hollow core fiber 114 and/or the optical amplifier 110. The at least one piezoelectric-based fiber stretcher is configured to modify the optical length of one or more optical fibers in the optical cavity based on a feedback or control signal. In particular, the piezoelectric-based fiber stretcher is controlled to maintain a particular optical cavity length, so the repetition rate of the mode-locked laser 100A is consistent.

In some examples where the mode-locked laser comprises a linear resonator cavity, the saturable absorber 116 and/or the output coupler 112 can be mounted on a piezoelectric-based positioner instead of or in addition to using a piezoelectric-based fiber stretcher as discussed above. In these examples, the one or more piezoelectric-based positioners are configured to modify the position of the saturable absorber 116 and/or the output coupler 112 in the optical cavity based on a feedback or control signal. In particular, the piezoelectric-based positioner is controlled to maintain a particular optical cavity length, so the repetition rate of the mode-locked laser 100A is consistent.

In some examples, the entire mode-locked laser 100 or certain sections of fiber are temperature controlled. The mode-locked laser 100 is configured to modify the temperature using a feedback control signal to maintain a constant repetition rate for the mode-locked laser 100A. In some examples, fast changes in mode-locked laser 100A frequency are compensated using the piezoelectric-based elements discuss above and slow drifts/changes are compensated using feedback to change temperature. This dual feedback approach allows the piezoelectric-based elements to operate at center of their compensation range, preventing them from reaching the end of their compensation range.

FIG. 1B is a block diagram of an alternative mode-locked laser 100B that utilizes a hollow core fiber 114 according to some aspects of the present disclosure. In some examples, the mode-locked laser 100B includes a pump laser 103, a WDM 109, an optical amplifier 110, an output coupler 112, a hollow core fiber 114, and a saturable absorber 116.

The mode-locked laser 100B includes similar components to those included in mode-locked laser 100A described above with respect to FIG. 1A. Similar reference numerals are used in FIG. 1B for the similar components and only the differences in components and operation will be discussed with reference to FIG. 1B.

In the example shown in FIG. 1B, the pump laser 103 is optically coupled to the WDM 109, which is optically coupled to the dielectric mirror 112. In some examples, the pump laser 103 is optically coupled to the WDM 109 using one or more optical fibers 106 and a FC/APC connector. In some examples, the WDM 109 is optically coupled to the output coupler 112 using one or more optical fibers 111. In some examples, the WDM 109 optically couples to the one or more fibers 111 with a FC/PC connector. In some examples, the one or more optical fibers 106 include a 980 nm polarization maintaining solid core fiber or standard single mode fiber which is not polarization maintaining. In some examples, the one or more optical fibers 111 include a 1550 nm polarization maintaining solid core fiber

In some examples, the pump laser 103 generates light with a wavelength of approximately 980 nanometers. This is an example of pump wavelength for erbium-doped fibers. In examples where the optical amplifier 110 is doped with a different rare-earth mineral, the wavelength of the light generated by the pump laser 103 is configured based on the pump wavelength for the particular mineral used to dope the fiber. The light produced by the pump laser 103 is coupled into the resonator cavity of the mode-locked laser 100B through the WDM 109 to the output coupler 112.

In the example shown in FIG. 1B, the hollow core fiber 114 is optically coupled to the optical amplifier 110 using a splice or free-space coupling 107. In some examples, the splice or free-space coupling 107 is zero-degree aligned and polarization maintaining such that the optical coupling between the hollow core fiber 114 maintains the frequency and polarization of the light.

FIG. 1C is a block diagram of an alternative mode-locked laser 100C having a ring resonator that utilizes a hollow core fiber 114 according to some aspects of the present disclosure. In some examples, the mode-locked laser 100C includes a pump laser 104, a WDM 105, an optical amplifier 110, an output coupler 113, a hollow core fiber 114, and a saturable absorber 117.

The mode-locked laser 100C includes similar components to those included in mode-locked lasers 100A and 100B described above with respect to FIGS. 1A and 1B. Similar reference numerals are used in FIG. 1C for the similar components and only the differences in components and operation will be discussed with reference to FIG. 1C.

In the example shown in FIG. 1C, the pump laser 104 is optically coupled to the WDM 105, which is optically coupled to the optical amplifier 110 and the hollow core fiber 114. In some examples, the pump laser 104 is optically coupled to the WDM 105 using one or more optical fibers 106 and a FC/APC connector. The optical amplifier is optically coupled to the output coupler 113 opposite the WDM 105. The hollow core fiber 114 is optically coupled to a saturable absorber 117 opposite the WDM 105. The saturable absorber 117 is optically coupled to an output coupler 113 using one or more optical fibers 111 and a FC/APC. In some examples, the one or more optical fibers 106 include a 980 nm polarization maintaining solid core fiber or standard single mode fiber which is not polarization maintaining. In some examples, the one or more optical fibers 111 include a 1550 nm polarization maintaining solid core fiber.

The output coupler 113 in the example shown in FIG. 1C is configured to transmit a particular percentage of the light directed towards the output coupler 113 to an external component and transmit a particular percentage of the light directed toward the output coupler 113 to the optical amplifier 110 such that it is recirculated through the ring resonator. In some examples, the output coupler 113 is configured to include an isolator that allows transmission of light in one direction within the mode-locked laser 100C. In the example shown in FIG. 1C, the isolator would direct the light from the output coupler in the direction of the optical amplifier 110 within the mode-locked laser 100C. In some examples, the output coupler 113 is configured to transmit ten percent of the light directed towards the output coupler 113 to an external component and is configured to transmit ninety percent of the light directed towards the output coupler 113 optical amplifier 110 such that it is recirculated through the ring resonator.

The saturable absorber 117 is configured to facilitate in the generation of a mode-locked laser. In some examples, the saturable absorber 117 is configured to be a semiconductor saturable absorber. In some examples the semiconductor saturable absorber consists of a substrate material, with layers of dielectric film, and a semiconductor material layer. The saturable absorber 117 generates ultrashort pulses for passive mode locking of the mode-locked laser 100C. In some examples, the saturable absorber 117 optically couples to the hollow core fiber 114 with free space coupling.

In some examples, the pump laser 104 generates light with a wavelength of approximately 980 nanometers. In some examples, the pump laser 104 generates light with a wavelength of approximately 1480 nanometers. These are examples of pump wavelengths for erbium-doped fibers. In examples where the optical amplifier 110 is doped with a different rare-earth mineral, the wavelength of the light generated by the pump laser 104 is configured based on the pump wavelength for the particular mineral used to dope the fiber. The light produced by the pump laser 104 is coupled into the ring resonator cavity of the laser resonator 100C through the WDM 105.

For mode-locked lasers 100A, 100B, 100C, the hollow core fiber 114 is configured to be less susceptible to ambient radiation and fluctuations in ambient temperature. The mode-locked lasers 100A, 100B, 100C can tolerate larger amounts of radiation and fluctuations in temperature because of the hollow core fiber 114. In particular, the effect of radiation and temperature is reduced such that feedback compensations applied to the mode-locked lasers 100A, 100B, 100C are sufficient enough to counteract changes of the optical cavity length induced by ambient radiation or temperature.

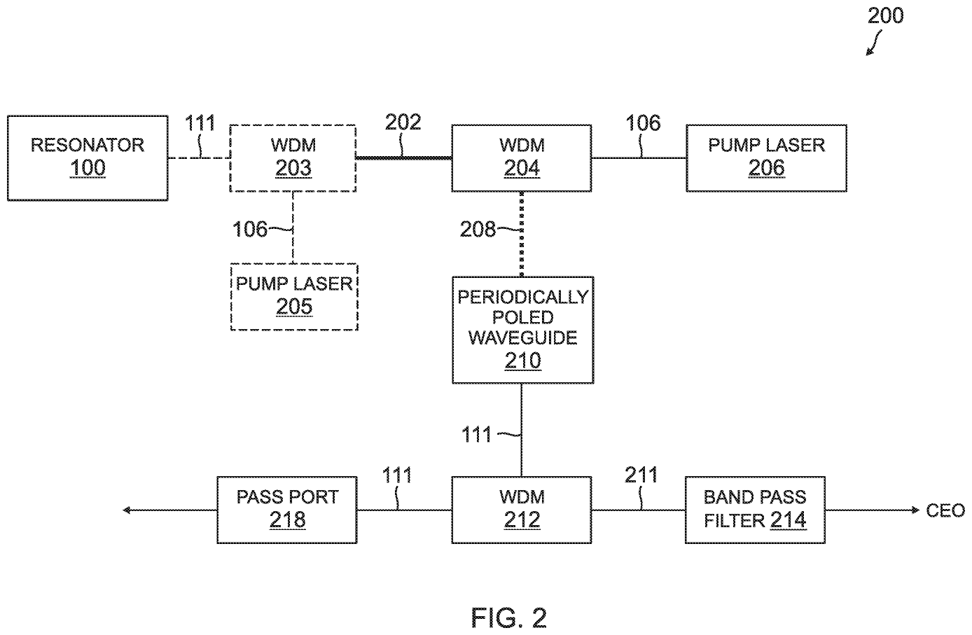

FIG. 2 is a block diagram of an optical frequency comb generator 200 according to an aspect of the present disclosure. In the example shown in FIG. 2, the optical frequency comb generator 200 includes a mode-locked laser 100 (such as, for example mode-locked laser 100A, mode-locked laser 100B, or mode-locked laser 100C as shown in FIGS. 1A, 1B, and 1C, respectively), a second optical amplifier 202, a second WDM 204, a second pump laser 206, a highly non-linear optical fiber (HNLF) 208, a periodically poled waveguide 210, a third WDM 112, a band pass filter 214, and a pass port 218. In some examples, as shown in FIG. 2 in dashed lines, the optical frequency comb additionally includes a WDM 203, one or more optical fibers 106, 111, and a pump laser 205. The discussion of the mode-locked laser 100A, 100B, 100C with respect to FIGS. 1A, 1B, and 1C applies to the mode-locked laser 100 of FIG. 2 and vice versa. In some examples, the one or more optical fibers 106 include a 980 nm polarization maintaining solid core fiber or standard single mode solid core fiber which is not polarization maintaining. In some examples, the one or more optical fibers 111 include a 1550 nm polarization maintaining solid core fiber.

In the example shown in FIG. 2, the second optical amplifier 202 is optically coupled to the output coupler 112, 113 of the mode-locked laser 100. In some examples, the second optical amplifier 202 is optically coupled to the dielectric mirror 112, 113 of the resonator using one or more optical fibers 111. In some examples, when the optical frequency comb generator 200 includes the example mode-locked laser 100B, the second optical amplifier 202 is optically coupled to the first WDM 109 using one or more optical fibers 111.

Alternatively, as shown in FIG. 2, a WDM 203 can be optionally included and optically coupled between the mode-locked laser 100 and the second optical amplifier 202. In some examples, the WDM 203 is optically coupled to the mode-locked laser 100 with one or more optical fibers 111. The WDM 203 is optically coupled to a pump laser 205. In some examples, the WDM 203 is optically coupled to the pump laser with one or more optical fibers 106. In some examples, the WDM may include an isolator to prevent light generated by the Erbium fiber from reaching the resonator. In some examples, the one or more optical fibers 106 include a 980 nm polarization maintaining solid core fiber or standard single mode solid core fiber which is not polarization maintaining. In some examples, the one or more optical fibers 111 include a 1550 nm polarization maintaining solid core fiber.

Connections to the optical fibers 111, where not described otherwise with respect to the frequency comb generator 200, are implemented using a splice or free-space coupling. In some examples, the splice and free-space coupling are zero degree aligned and are polarization maintaining. Thus, when connecting a component to the optical fibers 111, the splice or free-space coupling maintains the frequency and polarization of the light.

The second optical amplifier 202 is configured to amplify the light traveling along its length. In some examples, the second optical amplifier 202 is an erbium-doped fiber. In some examples, alternate rare-earth minerals could be used in the second optical amplifier 202 such as, for example, neodymium, ytterbium, thulium, praseodymium, and holmium. In some examples, the second optical amplifier 202 is polarization maintaining and has a core of 4 μ in diameter. In some examples, the second optical amplifier 202 is doped such that the absorption at the pump wavelength is approximately 80 dB/m.

The second optical amplifier 202 is pumped using the second pump laser 206, which is optically coupled to the second optical amplifier 202 via the second WDM 204. In examples where the second optical amplifier 202 is an erbium doped fiber, the second pump laser 206 is configured to produce light at a wavelength of 980 nm. In examples where the second optical amplifier 202 is doped with a different rare-earth mineral, the wavelength of the light generated by the second pump laser 206 is configured based on the pump wavelength for the particular mineral used to dope the fiber. When another WDM 203 is included between the mode-locked laser 100A, 100B,100C and optical amplifier 202, the pump laser 205 and the second pump laser 206 together pump light forwards and backwards along the second optical amplifier 202, producing a pulsed compression of the laser output from the mode-locked laser 100.

In some examples, the second WDM 204 is optically coupled to the second pump laser 206 using one or more optical fibers 106. In some examples, the second pump laser 206 and the second WDM 204 optically couple to the one or more optical fibers 106 with a FC/APC connector. In some examples, the one or more optical fibers 106 include a 980 nm polarization maintaining solid core fiber or standard single mode fiber which is not polarization maintaining. The second optical amplifier 202 is optically coupled to the second WDM 204. In some examples, the second optical amplifier 202 and the second WDM 204 are optically coupled using one or more optical fibers 111. In some examples, the optical fiber has a length of approximately 18 cm. In some examples, the one or more optical fibers 111 include a 1550 nm polarization maintaining solid core fiber.

In some examples, the second WDM 204 outputs approximately 20% of the light from the optical amplifier 202. In some examples, the WDM 204 is coupled to an output via one or more optical fibers 111 and a FC/APC connector. In some examples, the one or more optical fibers 111 include a 1550 nm polarization maintaining solid core fiber.

The second WDM 204 is optically coupled to a highly non-linear optical fiber (HNLF) 208. In some examples, the second WDM 204 is optically coupled to the highly non-linear optical fiber 208 via one or more polarization maintaining optical fibers 106. In some examples, the second WDM 204 and highly non-linear optical fiber 208 are optically coupled using one or more optical fibers 111 with a combined length of approximately 37.5 cm. In some examples, the one or more optical fibers 111 are 1550 nm polarization maintaining solid core fibers that are spliced together.

The highly non-linear optical fiber 208 broadens the spectrum of the light output by the optical amplifier 202. In some examples, the highly non-linear optical fiber 208 is configured to be polarization maintaining. In some examples, the highly non-linear optical fiber 208 is approximately 48 cm in length. In some examples, the highly non-linear optical fiber 208 with dispersion characteristics of 5.7 ps/nm/km.

The highly non-linear optical fiber 208 is optically coupled to the periodically poled waveguide 210. In some examples, the highly non-linear optical fiber 208 is optically coupled to the periodically poled waveguide 210 using one or more optical fibers 111. In some examples, the one or more optical fibers 111 include a 1550 nm polarization maintaining solid core fiber. In some examples, the highly non-linear optical fiber 208 and periodically poled waveguide 210 are optically coupled to the one or more fibers 111 with a FC/APC connector. In some examples, the optical one or more fibers ill optically coupled between the highly non-linear optical fiber and the FC/APC connector is approximately 8 cm in length. In some examples, the optical fiber 111 optically coupled between the FC/APC connector and the periodically poled waveguide 210 is configured to be as short as possible. In some examples, the one or more optical fibers 111 include a 1550 nm polarization maintaining solid core fiber.

In some examples, the periodically poled waveguide 210 is configured to double a portion of the broadened spectrum output by the highly non-linear fiber 208. In some examples, the periodically poled waveguide 210 is configured to double certain frequencies of the optical frequency comb generator 200 output around a selected wavelength. In some examples, the periodically poled waveguide 210 is a periodically poled potassium titanyl phosphate (PPKTP) waveguide. In other examples, the periodically poled waveguide 210 is a periodically poled lithium triborate (PPLT) waveguide or a periodically poled lithium niobite (PPLN) waveguide.

At the periodically poled waveguide 210, the optical frequency comb generator 200 has produced at least one comb mode characteristic frequency at one or more equally spaced frequencies. The at least one comb mode characteristic frequencies at double the frequency interferes with one of the original comb modes near this frequency to produce a beat note characteristic of the carrier envelope offset (CEO) frequency.

In some examples, the output of the periodically poled waveguide 210 is coupled to a pass port 218. In some examples, the pass port 218 is used to provide the optical frequency comb output to an external system.

For a reliable frequency comb output, the frequency comb generator 200 stabilizes the repetition rate and carrier-envelope offset frequency of the pulses generated by the mode-locked laser 100 using feedback. In some examples, the frequency comb output is locked with a stable laser (for example, a laser locked to a frequency standard) to monitor and stabilize the repetition rate of the mode-locked laser 100. In some examples, the frequency comb generator 200 is configured to measure the variation in repetition rate between the frequency comb output and the stable laser (for example, using a beat signal) and to provide feedback to the mode-locked laser 100 to stabilize the repetition rate. In some examples, the repetition rate of the mode-locked laser 100 is controlled using feedback to modify a piezoelectric-based fiber stretcher in the resonator cavity or to modify the temperature of the mode-locked laser 100. By making these modifications, variation in the optical cavity length, which causes variation in the repetition rate of the mode-locked laser 100, can be controlled.

In some examples, the periodically poled waveguide 210 is coupled to the pass port 218 via a third WDM 212, which splits the output of the periodically poled waveguide 210. In some examples, the third WDM 212 is optically coupled to the band pass filter 214. In some examples, the band pass filter 214 is configured to have a center frequency of approximately 980 nanometers. In some examples, the periodically poled waveguide 210 and the third WDM 212 are optically coupled using one or more optical fibers 111. In some examples, the third WDM 212 and the pass port 218 are optically coupled using one or more optical fibers 111. In some examples, the one or more optical fibers 111 include a 1550 nm polarization maintaining solid core fiber. In some examples, the third WDM 212 and the band pass filter 214 are optically coupled using one or more optical fibers 211. In some examples, the one or more optical fibers 211 include a 980 nm polarization maintaining solid core fiber.

Connections to the optical fibers 211 are implemented using a splice or free-space coupling. In some examples, the splice and free-space coupling are zero degree aligned and are polarization maintaining. Thus, when connecting a component to the optical fibers 211 the splice or free-space coupling maintains the frequency and polarization of the light.

In the example shown in FIG. 2, the carrier-envelope offset (CEO) frequency is stabilized using a feedback system. In some examples, the output of the band pass filter 214 is used for measuring the carrier-envelope offset CEO frequency. In particular, the CEO frequency is measured by detecting a beat signal between a frequency doubled lower frequency portion of the comb spectrum output by the periodically poled waveguide 210 with a higher frequency portion of the comb spectrum (assuming the comb spectrum covers an optical octave). The measured CEO frequency is used as feedback to modify the pump laser 102, 103, 104 of the mode-locked laser 100. In some examples, the current and/or pump power provided to the pump laser is modified to control the CEO frequency such that it is a consistent known value.

In alternative examples, the optical frequency comb generator 200, particularly the periodically poled waveguide 210, is configured to stabilize the CEO frequency by cancelling it using difference frequency generation. In such examples, the periodically poled waveguide 210 is configured to generate the difference frequency of different parts of the comb spectrum, which produces a frequency comb that is CEO free, and feedback to the mode-locked laser 100 is not necessary.

Using a hollow core fiber within the oscillator cavity, the optical frequency comb generator 200 can operate in an environment prone to large fluctuations in radiation and temperature. Even when subjected to large amounts of radiation and fluctuations in temperature, the optical frequency comb generator 200 can stabilize the optical frequency comb output through feedback loops and sufficient modifications to the characteristics of the optical cavity.

### EXAMPLE EMBODIMENTS

Example 1 includes a mode-locked laser, comprising: a resonator cavity comprising: a saturable absorber; an output coupler; a hollow core fiber optically coupled to the saturable absorber; and an optical amplifier optically coupled between the hollow core fiber and the output coupler; a first pump laser; and a wavelength division multiplexer optically coupled to the first pump laser, wherein the wavelength division multiplexer is configured to couple light from the first pump laser into the resonator cavity to pump the optical amplifier; wherein the mode-locked laser is configured to generate a pulse waveform at a repetition rate of approximately 100 MHz to 200 MHz.

Example 2 includes the mode-locked laser of Example 1, wherein the resonator cavity is a linear resonator cavity, wherein the wavelength division multiplexer is optically coupled between the hollow core fiber and the optical amplifier, wherein the saturable absorber is a semiconductor saturable absorber mirror (SESAM), and wherein the output coupler includes a dielectric mirror.

Example 3 includes the mode locked laser of Example 1, wherein the resonator cavity is a ring resonator cavity, wherein the wavelength division multiplexer is optically coupled between the hollow core fiber and the optical amplifier, wherein the saturable absorber is a semiconductor saturable absorber.

Example 4 includes the mode-locked laser of Example 1, wherein the resonator cavity is a linear resonator cavity, wherein the wavelength division multiplexer is optically coupled to the output coupler, wherein the wavelength division multiplexer is configured to couple light from the first pump laser into the resonator cavity through the output coupler, wherein the saturable absorber is a semiconductor saturable absorber mirror (SESAM), and wherein the output coupler includes a dielectric mirror.

Example 5 includes the mode-locked laser of any of Examples 1-4, wherein the hollow core fiber and the optical amplifier are optically coupled together via splicing or free-space coupling.

Example 6 includes the mode-locked laser of any of Examples 1-5, further comprising at least one piezoelectric fiber stretcher in the resonator cavity.

Example 7 includes the mode-locked laser of any of Examples 1-6, wherein at least one of the saturable absorber or the output coupler is mounted on a piezoelectric positioner.

Example 8 includes the mode-locked laser of any of Examples 1-7, wherein at least one of the saturable absorber, the hollow core fiber, the optical amplifier, the output coupler, and the wavelength division multiplexer are configured to be polarization maintaining.

Example 9 includes the mode-locked laser of any of Examples 1-8, wherein the optical amplifier comprises an optical doped fiber wherein the doped optical fiber comprises an optical fiber doped with one of an erbium, neodymium, ytterbium, thulium, praseodymium, or holmium.

Example 10 includes the mode-locked laser of Example 9, wherein the doped optical fiber comprises one of an erbium-doped fiber.

Example 11 includes the mode-locked laser of any of Examples 1-10, wherein a length of the resonator cavity is approximately fifty centimeters to one meter.

Example 12 includes an optical frequency comb generator, comprising: a mode-locked laser, comprising: a resonator cavity including: a saturable absorber; and a hollow core fiber optically coupled to the saturable absorber; a first optical amplifier optically coupled to the hollow core fiber; an output coupler optically coupled to the first optical amplifier; a first pump laser; and a wavelength division multiplexer optically coupled to the first pump laser, wherein the wavelength division multiplexer is configured to couple light from the first pump laser into the resonator cavity to pump the first optical amplifier, wherein the mode-locked laser is configured to operate at a repetition rate of approximately 100 MHz to 200 MHz; a second optical amplifier optically coupled to the output coupler; a second pump laser; a second wavelength division multiplexer optically coupled to the second pump laser and the second optical amplifier, wherein the second wavelength division multiplexer is configured to couple light from the second pump laser to pump the second optical amplifier; a highly non-linear optical fiber optically coupled to the second wavelength division multiplexer via one or more optical fibers; and a periodically poled waveguide optically coupled to the highly non-linear optical fiber via one or more optical fibers.

Example 13 includes the optical frequency comb generator of Example 12, wherein the resonator cavity is a linear resonator cavity, wherein the first wavelength division multiplexer is optically coupled between the hollow core fiber and the optical amplifier wherein the saturable absorber is a semiconductor saturable absorber mirror, and wherein the output coupler includes a dielectric mirror.

Example 14 includes the optical frequency comb generator of Example 12, wherein the resonator cavity is a ring resonator cavity, wherein the first wavelength division multiplexer is optically coupled between the hollow core fiber and the optical amplifier, wherein the saturable absorber is a semiconductor saturable absorber.

Example 15 includes the optical frequency comb generator of Example 12, wherein the resonator cavity is a linear resonator cavity, wherein the first wavelength division multiplexer is optically coupled to the dielectric mirror, wherein the wavelength division multiplexer is configured to couple light from the first pump laser into the resonator cavity through the output coupler, wherein the saturable absorber is a semiconductor saturable absorber mirror, and wherein the output coupler includes a dielectric mirror.

Example 16 includes the optical frequency comb generator of any of Examples 12-15, wherein at least one of the first optical amplifier and the second optical amplifier comprise an erbium-doped fiber.

Example 17 includes the optical frequency comb generator of any of Examples 12-16, wherein the periodically poled waveguide comprises one of a periodically poled lithium niobate, a periodically poled lithium triobate, or a periodically poled potassium titanyl phosphate.

Example 18 includes the optical frequency comb generator of any of Examples 12-17, further comprising a third wavelength division multiplexer optically coupled to the periodically poled waveguide, wherein the third wavelength division multiplexer is configured to output a signal used to tune the resonator cavity.

Example 19 includes the optical frequency comb generator of any of Examples 12-18, wherein the optical frequency comb generator includes at least one feedback loop to adjust one or more of an optical length of the resonator cavity, a current provided to the first pump laser, a power level of the first pump laser, and a temperature of the femtosecond laser resonator.

Example 20 includes an optical frequency comb generator, comprising: a femtosecond mode-locked laser, comprising: an resonator cavity including: a semiconductor saturable absorber; a hollow core fiber optically coupled to the semiconductor saturable absorber; a first erbium-doped fiber optically coupled to the hollow core fiber; an output coupler optically coupled to the first erbium-doped fiber; and a first pump laser; and a wavelength division multiplexer optically coupled to the first pump laser, wherein the wavelength division multiplexer is configured to couple light from the first pump laser into the optical cavity to pump the first erbium-doped fiber; wherein the femtosecond mode-locked laser is configured to generate a pulse waveform at a repetition rate of approximately 100 MHz to 200 MHz; a second pump laser; a second wavelength division multiplexer optically connected the second pump laser and to the dielectric mirror via one or more optical fibers; a second erbium-doped fiber optically coupled to the second wavelength division multiplexer; a third pump laser; a third wavelength division multiplexer optically coupled to the third pump laser and the second erbium-doped fiber, wherein the third wavelength division multiplexer is configured to couple light from the second pump laser and the third pump laser to pump the second erbium doped fiber; a highly non-linear optical fiber optically coupled to the third wavelength division multiplexer via one or more optical fibers; and a periodically poled waveguide optically coupled to the highly non-linear optical fiber via one or more optical fibers.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A mode-locked laser, comprising:
a resonator cavity comprising:
a saturable absorber;
an output coupler;
a hollow core fiber optically coupled to the saturable absorber; and
an optical amplifier optically coupled between the hollow core fiber and the output coupler;
a first pump laser; and
a wavelength division multiplexer optically coupled to the first pump laser, wherein the wavelength division multiplexer is configured to couple light from the first pump laser into the resonator cavity to pump the optical amplifier;
wherein the mode-locked laser is configured to generate a pulse waveform at a repetition rate of approximately 100 MHz to 200 MHz.

2. The mode-locked laser of claim 1, wherein the resonator cavity is a linear resonator cavity, wherein the wavelength division multiplexer is optically coupled between the hollow core fiber and the optical amplifier, wherein the saturable absorber is a semiconductor saturable absorber mirror (SESAM), and wherein the output coupler includes a dielectric mirror.

3. The mode locked laser of claim 1, wherein the resonator cavity is a ring resonator cavity, wherein the wavelength division multiplexer is optically coupled between the hollow core fiber and the optical amplifier, wherein the saturable absorber is a semiconductor saturable absorber.

4. The mode-locked laser of claim 1, wherein the resonator cavity is a linear resonator cavity, wherein the wavelength division multiplexer is optically coupled to the output coupler, wherein the wavelength division multiplexer is configured to couple light from the first pump laser into the resonator cavity through the output coupler, wherein the saturable absorber is a semiconductor saturable absorber mirror (SESAM), and wherein the output coupler includes a dielectric mirror.

5. The mode-locked laser of claim 4, wherein the hollow core fiber and the optical amplifier are optically coupled together via splicing or free-space coupling.

6. The mode-locked laser of claim 1, further comprising at least one piezoelectric fiber stretcher in the resonator cavity.

7. The mode-locked laser of claim 1, wherein at least one of the saturable absorber or the output coupler is mounted on a piezoelectric positioner.

8. The mode-locked laser of claim 1, wherein at least one of the saturable absorber, the hollow core fiber, the optical amplifier, the output coupler, and the wavelength division multiplexer are configured to be polarization maintaining.

9. The mode-locked laser of claim 1, wherein the optical amplifier comprises an optical doped fiber wherein the doped optical fiber comprises an optical fiber doped with one of an erbium, neodymium, ytterbium, thulium, praseodymium, or holmium.

10. The mode-locked laser of claim 9, wherein the doped optical fiber comprises one of an erbium-doped fiber.

11. The mode-locked laser from claim 1, wherein a length of the resonator cavity is approximately fifty centimeters to one meter.

12. An optical frequency comb generator, comprising:
a mode-locked laser, comprising:
a resonator cavity including:
a saturable absorber;
a hollow core fiber optically coupled to the saturable absorber;
a first optical amplifier optically coupled to the hollow core fiber;
and
an output coupler optically coupled to the first optical amplifier;
a first pump laser; and
a wavelength division multiplexer optically coupled to the first pump laser, wherein the wavelength division multiplexer is configured to couple light from the first pump laser into the resonator cavity to pump the first optical amplifier, wherein the mode-locked laser is configured to operate at a repetition rate of approximately 100 MHz to 200 MHz
a second optical amplifier optically coupled to the output coupler;
a second pump laser;
a second wavelength division multiplexer optically coupled to the second pump laser and the second optical amplifier, wherein the second wavelength division multiplexer is configured to couple light from the second pump laser to pump the second optical amplifier;
a highly non-linear optical fiber optically coupled to the second wavelength division multiplexer via one or more optical fibers; and
a periodically poled waveguide optically coupled to the highly non-linear optical fiber via one or more optical fibers.

13. The optical frequency comb generator of claim 12, wherein the resonator cavity is a linear resonator cavity, wherein the first wavelength division multiplexer is optically coupled between the hollow core fiber and the optical amplifier wherein the saturable absorber is a semiconductor saturable absorber mirror, and wherein the output coupler includes a dielectric mirror.

14. The optical frequency comb generator of claim 12, wherein the resonator cavity is a ring resonator cavity, wherein the first wavelength division multiplexer is optically coupled between the hollow core fiber and the optical amplifier, wherein the saturable absorber is a semiconductor saturable absorber.

15. The optical frequency comb generator of claim 12, wherein the resonator cavity is a linear resonator cavity, wherein the first wavelength division multiplexer is optically coupled to the dielectric minor, wherein the wavelength division multiplexer is configured to couple light from the first pump laser into the resonator cavity through the output coupler, wherein the saturable absorber is a semiconductor saturable absorber mirror, and wherein the output coupler includes a dielectric mirror.

16. The optical frequency comb generator of claim 12, wherein at least one of the first optical amplifier and the second optical amplifier comprise an erbium-doped fiber.

17. The optical frequency comb generator of claim 12, wherein the periodically poled waveguide comprises one of a periodically poled lithium niobate, a periodically poled lithium triobate, or a periodically poled potassium titanyl phosphate.

18. The optical frequency comb generator of claim 12, further comprising a third wavelength division multiplexer optically coupled to the periodically poled waveguide, wherein the third wavelength division multiplexer is configured to output a signal used to tune the resonator cavity.

19. The optical frequency comb generator of claim 12, wherein the optical frequency comb generator includes at least one feedback loop to adjust one or more of an optical length of the resonator cavity, a current provided to the first pump laser, a power level of the first pump laser, and a temperature of the femtosecond laser resonator.

20. An optical frequency comb generator, comprising:
a femtosecond mode-locked laser, comprising:
an resonator cavity including:
a semiconductor saturable absorber;
a hollow core fiber optically coupled to the semiconductor saturable absorber;
a first erbium-doped fiber optically coupled to the hollow core fiber;
an output coupler optically coupled to the first erbium-doped fiber;
and
a first pump laser; and
a wavelength division multiplexer optically coupled to the first pump laser, wherein the wavelength division multiplexer is configured to couple light from the first pump laser into the optical cavity to pump the first erbium-doped fiber;
wherein the femtosecond mode-locked laser is configured to generate a pulse waveform at a repetition rate of approximately 100 MHz to 200 MHz;
a second pump laser;
a second wavelength division multiplexer optically connected the second pump laser and to the dielectric mirror via one or more optical fibers;
a second erbium-doped fiber optically coupled to the second wavelength division multiplexer;
a third pump laser;
a third wavelength division multiplexer optically coupled to the third pump laser and the second erbium-doped fiber, wherein the third wavelength division multiplexer is configured to couple light from the second pump laser and the third pump laser to pump the second erbium doped fiber;
a highly non-linear optical fiber optically coupled to the third wavelength division multiplexer via one or more optical fibers; and
a periodically poled waveguide optically coupled to the highly non-linear optical fiber via one or more optical fibers.
